(19) United States
(12) Patent Application Publication
(10) Pub. No.: US 2020/0218063 A1
(43) Pub. Date: Jul. 9, 2020

(54) SCANNING UNIT AND METHOD FOR SCANNING LIGHT

(71) Applicant: Blickfeld GmbH, Munich (DE)

(72) Inventors: Florian Petit, Munich (DE); Mathias Muller, Groebenzell (DE)

(21) Appl. No.: 16/639,710

(22) PCT Filed: Aug. 16, 2018
(86) PCT No.: PCT/DE2018/100715

§ 371 Date: Feb. 17, 2020

(30) Foreign Application Priority Data
Aug. 17, 2017 (DE) 10 2017 118 776.6

(51) Int. Cl. G02B 26/10; G01S 7/481

(52) U.S. Cl. CPC G02B 26/105; G01S 7/4817

(57) ABSTRACT

A scanning unit for scanning light comprises a deflection element with a mirrored surface and a support element. The deflection element is self-supporting, relative to the fixed structure. The scanning unit has one additional support element extending with an offset to the plane defined by the support element. The scanning unit has a controller in order to control an actuator which can resonantly excite a torsion mode of the support element and of the additional support element. Preferably, the support element and the deflection element are integrally formed and the support element and the further support element are not integrally formed. Preferably, both the support element and the further support element are designed as rod-type torsion springs. Preferably, the support element and the further support element are interconnected by bonding at their respective contact surfaces in an end region facing the fixed structure. The invention further relates to a method for producing a scanning unit.

### TECHNICAL AREA

Various examples relate to a scanning unit for scanning light by means of a deflection element. In various examples, at least one support element, which is designed to elastically couple the deflection element to a fixed structure, extends into a plane defined by a mirrored surface of the support element.

### BACKGROUND

The distance measurement of objects is desirable in various fields of technology. For example, it can be desirable in connection with applications of autonomous driving, detecting objects in the environment of vehicles, and particularly in determining a distance to objects.

One technique for the distance measurement of objects is the so-called LIDAR technology (known as light detection and ranging or sometimes also LADAR in English). In this process, pulsed laser light is emitted from an emitter. The objects in the environment reflect the laser light. These reflections can then be measured. By determining the travel time of the laser light, a distance to objects can be determined.

In order to detect the objects in the environment with spatial resolution, it may be possible to scan the laser light. Depending on the angle of radiation of the laser light, different objects in the environment can thereby be detected.

Various techniques are known for scanning light. For example, microelectromechanical system (MEMS) techniques can be used. In this case, a micromirror is released in a frame structure, e.g. using reactive ion beam etching of silicon. Refer, for example, to EP 2 201 421 B1.

However, such techniques often have the disadvantage that the scanning angle is comparatively limited. This means that the deflection of light is comparatively limited. In addition, production may be complicated. The scanning module may also require a comparatively large amount of space due to the frame structure.

JP 2015-99270 A discloses a technique in which two torsion springs extend into a plane defined by a mirrored surface. Such a configuration has the disadvantage that the bending stiffness is comparatively low for bending perpendicular to this plane.

### Abstract

Therefore, there is a need for improved techniques regarding the scanning of light. In particular, there is a need for such techniques which eliminate or minimize at least some of the aforementioned disadvantages.

This object is achieved with the features of the independent claims. The dependent claims define embodiments.

A scanning unit for scanning light comprises a deflection element. The deflection element comprises a mirrored surface. The scanning unit also comprises at least one support element. The at least one support element extends away from a circumference of the mirrored surface. The at least one support element is configured to elastically couple the deflection element to a fixed structure. The deflection element is self-supporting, relative to the fixed structure, through a continuous circumferential angle of at least 200° of a circumference of the mirrored surface.

In other words, the coupling of the deflection element to the fixed structure may be limited to a comparatively small area. In particular, two-point coupling at opposite sides can be avoided, as is described, for example, in US 2014 0300 942 A1. The scanning unit can thereby be produced more compactly and simply. In addition, larger scanning angles are possible.

A LIDAR system could comprise such a scanning unit.

A method for operating a scanning unit for scanning light comprises the actuation of at least one actuator. This takes place in order to resonantly deflect at least one support element. The at least one support element extends into a plane defined by a mirrored surface of a deflection element. The deflection element is self-supporting, relative to the fixed structure, through a continuous circumferential angle of at least 200° of a circumference of the mirrored surface.

A method for producing a scanning unit for scanning light comprises: in a first etching process of a first wafer, creating a deflection element and at least one support element extending away from the deflection element, in the first wafer; in a second etching process of a second wafer, creating at least one additional support element, in the second wafer; bonding of the first wafer to the second wafer; and releasing of the deflection element of the at least one support element and of the at least one additional support element.

The previously shown features and features to be described in the following may not only be used in the corresponding explicitly shown combinations but also in further combinations or in isolation, without going beyond the protective scope of the present invention.

### SHORT DESCRIPTION OF THE FIGURES

FIG. 1 is a schematic view of a scanning unit according to various examples.

FIG. 2 is a schematic perspective view of the scanning unit according to the example from FIG. 1.

FIG. 3 schematically illustrates the deflection of a deflection element a scanning unit through torsion of four support elements of a scanning unit according to various examples.

FIG. 4 is a schematic perspective view of a scanning unit according to various examples, wherein the mirrored surface of the corresponding deflection unit has a projection in which several support elements are arranged.

FIG. 5 is a schematic perspective view of the scanning unit according to the example from FIG. 4.

FIG. 6 is a schematic view with sectional view of the scanning unit according to the example from FIGS. 4 and 5.

FIG. 7 schematically illustrates a scanning unit according to various examples.

FIG. 8 schematically illustrates a scanner with two scanning units according to various examples.

FIG. 9 schematically illustrates a scanner with two scanning units according to various examples.

FIG. 10 schematically illustrates a scanner with two scanning units according to various examples.

FIG. 11 schematically illustrates a LIDAR system according to various examples.

FIG. 12 schematically illustrates a LIDAR system according to various examples.

FIG. 13 is a flowchart of an exemplary method.

FIG. 14 is a flowchart of an exemplary method.

### DETAILED DESCRIPTION OF EMBODIMENTS

The previously described properties, features, and advantages of this invention as well as the type and manner as to how they are achieved will become more clearly and noticeably understandable in the context of the following description of the exemplary embodiments, which are explained in greater detail in connection with the drawings.

In the following, the present invention is explained in greater detail by means of preferred embodiments, with reference to the drawings. The same reference numerals refer to equivalent or similar elements in the figures. The figures are schematic representations of various embodiments of the invention. Elements shown in the figures are not necessarily shown to scale. Rather, the various elements shown in the figures are reflected such that their function and general purpose will be understandable to one skilled in the art. Connections and couplings between functional units and elements shown in the figures can also be implemented as a direct connection or coupling. Functional units may be implemented as hardware, software, or a combination of hardware and software.

Various techniques for the scanning of light are described in the following. The subsequently described techniques can enable, for example, the 1-D or 2-D scanning of light. The scanning may characterize repeated emission of the light at different angles of radiation. To this end, the light may be deflected once or multiple times by means of a deflection unit of a scanner.

The deflection element may be formed, for example, by a mirror. The deflection element may also comprise a prism instead of the mirror. A mirrored surface may be provided.

The scanning may characterize the repeated scanning of different points in the environment by means of the light. To this end, sequentially different angles of radiation can be implemented. The sequence of angles of radiation can be specified by means of a superposed figure when, e.g., two degrees of freedom of movement are temporally—and optionally spatially—superposed for scanning. For example, the quantity of different points in the environment and/or the quantity of different angles of radiation can specify a scanning region. Larger scanning regions in this case correspond to larger scanning angles. In various examples, the scanning of light can occur by means of the temporal superposition and optionally a spatial superposition of two movements according to different degrees of freedom of at least one support element. A 2-D scanning region is then obtained. Sometimes, the superposed figure is characterized also as a Lissajous figure. The superposed figure may describe a sequence, with which different angles of radiation are implemented by means of the elastic, reversible movement of at least one support element.

It is possible to scan laser light in various examples. In doing so, coherent or incoherent laser light, for example, can be used. It would also be possible to use polarized or unpolarized laser light. For example, it would be possible for the laser light to be pulsed. For example, short laser pulses with pulse widths in the range of femtoseconds or picoseconds or nanoseconds can be used. For example, a pulse duration can be in a range of 0.5-3 ns. The laser light may have a wavelength in a range of 700-1800 nm, e.g. particularly 1550 nm or 950 nm. For the sake of simplicity, reference is made primarily to laser light in the following; the various examples described herein, however, may also be used for scanning light from other light sources, for example broadband light sources or RGB light sources. In general, RGB light sources herein characterize light sources in the visible spectrum, wherein the color space is covered through the superposition of multiple different colors—for example, red, green, blue or cyan, magenta, yellow, black.

In various examples, at least one support element, which has a shape- and/or material-induced elasticity, is used to scan light. Therefore, the at least one support element could also be characterized as a spring element or elastic suspension. The support element has a movable end. At least one degree of freedom of movement of the at least one support element can then be excited, for example a torsion and/or a transverse deflection. In this context, the support element is also characterized as a torsion spring element or flexure spring element. With a torsion spring element, the natural frequency of the torsion mode is less than the eigenmode of the bending mode; and with a flexible spring element, the natural frequency of the bending mode is less than the natural frequency of the torsion spring. A deflection element, which is connected to the movable end of the at least one support element, can be moved and/or deflected by means of such excitation of a movement.

It would also be possible, for example, that more than one single support element is used, e.g. two or three or four support elements. They can be arranged symmetrically with reference to one another as an option.

Every at least one support element may specifically be formed between the movable end and an opposite end, at which the respective support element is connected to an actuator, i.e. it may have none or no significant curvature in the standby position.

The at least one support element may have, for example, a length between the two ends in a range of from 2 mm to 15 mm, for example in a range of from 3 mm to 10 mm or, for example, in a range of from 5 mm to 7 mm.

In some examples, it would also be possible that at least one support element is produced from a wafer by means of MEMS techniques, i.e. by means of suitable lithography process steps, for example, through etching. For example, reactive ion beam etching could be used for the release from the wafer. A silicon-on-insulator (SOI) wafer could be used. For example, the dimensions of the at least one support element can thereby be defined perpendicular to the length if the insulator of the SOI wafer is used as the etch stop.

For example, the movable end of the support element could be moved in one or two dimensions—with a temporal and spatial superposition of two degrees of freedom of movement. To this end, one or more actuators may be used. For example, it would be possible that the movable end is tilted with respect to a securing of the at least one support element; this results in a curvature of the at least one support element. This can correspond to a first degree of freedom of movement; it can be characterized as a transverse mode (or sometimes also as a wiggle mode or flexure mode). Alternatively or in addition, it would be possible that the movable end is distorted along a longitudinal axis of the support element (torsion mode). This may correspond to a second degree of freedom of movement. The moving of the movable end makes it possible for the deflection element to be deflected and thus laser light to be radiated at various angles. An environment can thereby be scanned with the laser light. Depending on the strength of the movement of the movable end and/or the deflection of the deflection element, differently sized scanning regions can be implemented.

In the various examples described herein, it is possible to excite the torsion mode as an alternative or in addition to the transverse mode, i.e. a temporal and spatial superposition of the torsion mode and the transverse mode would be possible. However, this temporal and spatial superposition can also be suppressed. For example, the torsion mode can be excited and transverse modes can be suppressed in a targeted manner in some examples; the actuator can be configured accordingly, e.g. by using a closed-loop control. In other examples, other degrees of freedom of movement could also be implemented.

For example, the deflection element may comprise a prism or a mirror. For example, the mirror could be implemented by means of a wafer, for example a silicon wafer, or a glass substrate. For example, the mirror could have a thickness ranging from 0.05 μm to 0.1 mm. For example, the mirror could have a thickness of 25 μm or 50 μm. For example, the mirror could have a thickness ranging from 25 μm to 75 μm. For example, the mirror could be formed as a square, rectangle, or circle. For example, the mirror could have a diameter of from 3 mm to 12 mm or particularly 8 mm. The mirror also has a mirrored surface. The opposite back side can be structured, e.g. with ribs or other stiffening structures.

In general, such techniques can be used to scan light in the most varied of application areas. Examples comprise endoscopes and RGB projectors and printers and laser scanning microscopes. In various examples, LIDAR techniques can be used. The LIDAR techniques can be used to implement a distance measurement of objects in the environment with spatial resolution. For example, the LIDAR technique may comprise travel-time measurements of the laser light between the mirror, the object, and a detector. In general, such techniques can be used to scan light in the most varied of application areas. Examples comprise endoscopes and RGB projectors and printers. In various examples, LIDAR techniques can be used. The LIDAR techniques can be used to implement a distance measurement of objects in the environment with spatial resolution. For example, the LIDAR technique may comprise travel-time measurements of the laser light.

Together with a LIDAR technique, it may be possible to use the scanning unit for emitting laser light and for detecting laser light. This means that the detector aperture can also be defined via the deflection element of the scanning unit. Such techniques are sometimes characterized as spatial filtering. Through spatial filtering, it may be possible to obtain an especially high signal-to-noise ratio, because selective light is acquired from the particular direction into which the laser light is also being emitted. This prevents background radiation from being acquired from other regions from which no signal is expected. Especially large distances can be achieved by means of the high signal-to-noise ratio.

Various examples are based on the knowledge that it may often be desirable to use comparatively large mirrors in order to use a large detector aperture in connection with the spatial filtering and thus to obtain an especially high signal-to-noise ratio. At the same time however, it may be desirable to also implement an especially large scanning angle—e.g. greater than ±80°. This can make the use of imaging optics in the emitted beam path downstream of the scanning unit unnecessary (post-scanner optics), which makes the system simple and compact. Furthermore, various examples are based on the knowledge that it may be desirable to provide scanning units which are especially easy to produce—particularly with a high degree of automation, e.g. through wafer structuring by means of lithographic processes.

Various examples are furthermore based on the knowledge that it is often desirable to use comparatively large mirrors in order to emit laser light along a beam path with low divergence—without needing collimation optics between the mirror and the environment (i.e. in a post-scanner arrangement). Low divergence can especially be thereby achieved such that a large transmit aperture is available—defined by the mirror.

These and other objects are achieved by means of the techniques described herein.

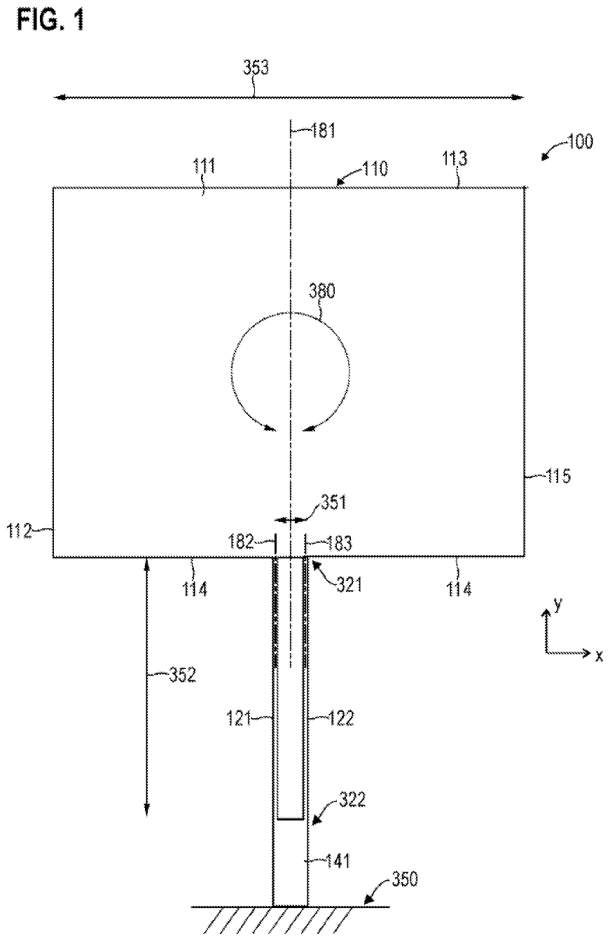

FIG. 1 illustrates aspects in relation to a scanning unit 100 according to various examples. FIG. 1 is a schematic view of a scanning unit 100. The scanning unit 100 comprises a deflection element 110 with a mirrored surface 111 (in the view from FIG. 1, the mirrored surface 111 lies in the drawing plane (i.e. the XY plane). The sides 112, 113, 114, 115 of the mirrored surface 111 are also shown in FIG. 1 and form a circumference of the mirrored surface 111.

While the mirrored surface 111 is formed as a rectangle in the example from FIG. 1, the mirrored surface 111 may also have a different shape in other examples; for example, it may be shaped as an ellipse or circle.

Typical side lengths 353 of the mirrored surface 111 range from 3 mm to 15 mm, optionally range from 5 mm to 10 mm.

In the example from FIG. 1, the scanning unit 100 also comprises two support elements 121, 122. The support elements 121, 122 are each connected to the deflection element 110 on a movable end 321. The support elements 121, 122 may be connected to an actuator, for example with piezo bending actuators (not shown in FIG. 1), at an end 322 opposite the movable end 321. The support elements 121, 122 are connected to a fixed structure 350 at the end 322—for example via the actuator. The fixed structure 350 defines the reference coordinate system, based on which a movement and/or deflection of the deflection element 110 is possible for scanning light due to elastic deformation of the support elements 121, 122.

FIG. 1 illustrates the deflection element 110 in a standby position. This means that there is no elastic deformation of the support elements 121, 122. For example, the corresponding actuator could be switched off. FIG. 1 shows that, in the standby position, the support elements 121, 122 are specifically formed between ends 321 and 322. Corresponding central axes 182, 183 of the support elements 121, 122 are shown in FIG. 1. The length 352 of the support elements 121, 122 along the Y-axis is typically in a range of from 3 mm to 15 mm. The width of the support elements 121, 122 along the X-axis is typically in a range of from 50 μm to 250 μm. The support elements 121, 122 may have a square cross-section. The support elements 121, 122 may also be shaped like a rod and thus be formed as torsion springs.

FIG. 1 also shows a torsion axis 181. Through twisting and turning of the support elements 121, 122 along their central axis 182, 183 and/or in relation to the torsion axis 181, a deflection and/or particularly a tilting of the deflection element 110 and thus the mirrored surface 111 can be established; the axis of rotation corresponds to the torsion axis 181 (in the example from FIG. 1, the mirrored surface 111 would be tilted left of the torsion axis 181 into the drawing plane and right of the torsion axis 181 out of the drawing plane). It is thereby possible to deflect laser light.

In the example from FIG. 1, it is clear that the deflection element 110 is self-supporting, relative to the fixed structure 350, along a large continuous circumferential angle 380 of almost 360°. In general, the deflection element could be self-supporting, relative to the fixed structure 350, along a continuous circumferential angle 380 of at least 200° of the circumference of the mirrored surface 111.

In particular, this means that only side 114 of the deflection element 110 is coupled to the fixed structure 350, i.e. the remaining sides 112, 113, 115 are self-supporting. There is no connection—for example via further elastic support elements—to the fixed structure 350 at the remaining sides 112, 113, 115. The remaining sides 112, 113, 115 are self-supporting in the environment.

Such a coupling of the deflection element 110 to the fixed structure 350 can mean that particularly large deflections of the deflection elements are possible. Especially large scanning regions can thereby be achieved. For example, scanning angles can be achieved of at least ±45°, optionally at least ±80°, optionally of at least ±120°, further optionally of at least ±180°.

The mirrored surface 111 could have, for example, side lengths 353 in a range of from 3 mm to 15 mm. The side lengths 353 may be within a range of 20% to 500% the length of the support elements 352. On the one hand, a large deflection of the deflection element 110 can thereby be achieved; at the same time however, this means that the inert mass of the deflection element 110 is not disproportionately large compared to the elasticity of the support elements.

In the example from FIG. 1, the deflection element 110 and the support elements 121, 122 are formed as a single piece. For example, it would be possible that the support elements 121, 122 and the deflection element 110 are released from a common wafer in a common lithographic/etching process. Thus, there is no material transition or material non-homogeneity in the region of the transition between the deflection element 110 and the support elements 121, 122; the corresponding region and/or the remaining regions can be produced particularly from a monocrystalline wafer.

Integrated production can be achieved using such techniques. In addition, the tolerance relative to tension can be particularly large in the region of the transition from the deflection element 110 to the support elements 121, 122, i.e. close to the end 321. Large scanning angles can thereby be achieved without damaging the material.

An end region 141—which can be engaged with the actuator—is formed as a single piece with the support elements 121, 122 and the deflection element 110.

In FIG. 1, the two support elements are arranged parallel to one another. In general, it would be possible that the central axes 182, 183 of the support elements 121, 122 form an angle with one another that is no greater than 20°, optionally no greater than 5°, further optionally no greater than 1°. Parallel kinematics can be established that enable large scanning angles by means of such an arrangement of the two support elements 121, 122. The deformation of the two support elements 121, 122 may correspond to one another.

The parallel kinematics are furthermore supported in that the distance 351 between the central axes 182, 183 is comparatively small in the region of the movable end 321. For example, the distance 351 may be much less than the length 352 of the support elements and furthermore even much less than the circumferential length of the mirrored surface 111. For example, it would be possible that this distance 351 is no greater than 40% of the circumferential length (i.e. the total of the lengths of the sides 112-115), optionally no greater than 10%, further optionally no greater than 5%.

In addition to the parallel kinematics by means of the two support elements 121, 122, the use of two support elements also supports the resistance to external shocks. This means that—despite the large scanning angle—a great deal of resistance to shocks can be achieved.

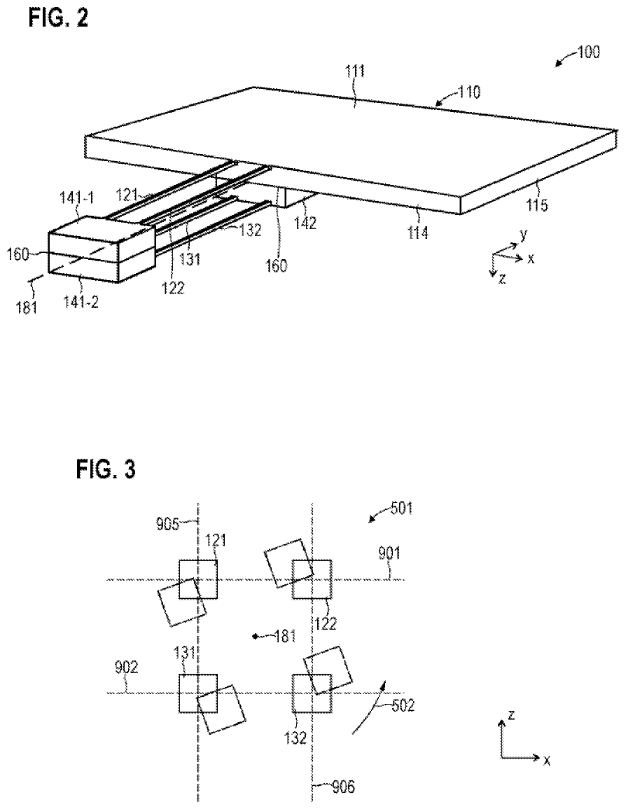

In order to further promote this resistance and to reduce nonlinear effects due to the anisotropic geometry, further support elements 121, 122 may also be provided. A corresponding example is shown in FIG. 2.

FIG. 2 illustrates aspects in relation to a scanning unit 100 according to various examples. FIG. 2 is a perspective view.

In the example from FIG. 2, the scanning unit 100 comprises a total of four support elements 121, 122, 131, 132. Support elements 121, 122 in this case are arranged offset in the Z direction in relation to support elements 131, 132, i.e. perpendicular to the mirrored surface 111. In particular, the support elements 131, 132 are also offset in relation to the plane defined by the mirrored surface 111. The support elements 131, 132 are in the standby position, offset in the Z direction in relation to the deflection element 110. The support elements 131, 132 are connected to the back side of the deflection element 110 via an interface element 142 and are thus also configured to elastically couple the deflection element to the fixed structure 350.

In doing so, the various support elements 121, 122, 131, 132 and/or the central axes thereof (not shown in FIG. 2 for reasons of clarity) are all parallel to one another. In general, the central axes of the support elements 121, 122, 131, 132, however, also form a comparatively small angle with one another, e.g. angles that are no greater than 10° or no greater than 5° in the standby state. The parallel kinematics of the support elements 121, 122, 131, 132 are thereby supported.

FIG. 2 shows that the plane (plane 901, cf. also FIG. 3) in which support elements 121, 122 are arranged is offset compared to the plane in which support elements 131, 132 are arranged (plane 902, cf. also FIG. 3). These two planes are parallel to one another in the example shown in FIG. 2; however, they could form, in general, an angle no greater than 5° with one another, optionally no greater than 1°. The parallel kinematics of the support elements 121, 122, 131, 132 can be supported by means of the XY planes arranged essentially in parallel.

In the example from FIG. 2, the support elements 121, 122, the end region 141-1, as well as the deflection element 110 are formed as a single piece with the mirrored surface 111, i.e. released from the same wafer for example, such that bonding, etc. becomes unnecessary.

The support elements 131, 132, the end region 141-2, as well as an interface element 142 are also formed as a single piece. Combined, one-piece part 131, 132, 141-2, 142 is connected to combined, one-piece part 141-1, 121, 122, 110 at contact surfaces 160, for example, by means of adhesives, wafer bonding, anodic bonding, fusion bonding, direct bonding, eutectic bonding, thermocompression bonding, adhesive bonding, etc. The bonding could occur, for example, at a point in time in which parts 131, 132, 141-2, 142 as well as 141-1, 121, 122, 110 have not yet been released from the corresponding wafer; this means that two wafers, each of which supports one of the two parts, for example, in an array, are placed in contact with each other in order to execute the bonding. The structures can only be released after this. The scanning unit 100 can be produced in an especially simple and robust manner by means of such two-part production. At the same time, high resistance to shocks, high resonance frequencies, and large scanning angles can be created by the 3-D structuring in the X direction, Y direction, and Z direction.

FIG. 2 shows that a thickness of the support elements 121, 122, 131, 132 perpendicular to the mirrored surface 111—i.e. in the Z direction—is respectively less than a thickness of the deflection element 110 in the Z direction. This can support a high degree of elasticity of the support elements 121, 122, 131, 132, while deformation of the mirrored surface 111 is simultaneously reduced during movement. The thickness of the support elements 121, 122, 131, 132 in the Z direction can be defined by a suitable etch stop during the etching process for the release from the wafer. For example, an insulating layer in an SOI wafer can be used as the etch stop.

The deflection element could have structuring on the back sides, i.e. on the back side opposite the mirrored surface 111, e.g. fins or a rib structure (not shown in FIG. 2). This reduces the inert mass of the deflection element 110 and thus increases the resonance frequency; on the other hand, deformation of the mirrored surface 111 is prevented during movement.

FIG. 3 illustrates aspects in relation to a torsion mode 501, which enable a deflection of the deflection element 110. In the example from FIG. 3, support elements 121, 122 as well as 131, 132 are shown, according to the example from FIG. 2 (in this case, FIG. 3 shows the standby state indicated by the solid line and the deflected state indicated by the dashed line). The support elements 121, 122, 131, 132 are arranged symmetrically in relation to the torsion axis 181; therefore, nonlinear effects are prevented. Large deflections 502, e.g. of up to 180°, are thereby possible This enables large scanning angles.

FIG. 3 also illustrates aspects in relation to the arrangement of support elements 121, 122 as well as 131, 132. Support elements 121, 122 extend into plane 901 in the standby position. The mirrored surface 111 also extends into this plane, cf. FIG. 2. In contrast, support elements 131, 132 extend into plane 902, wherein plane 902, however, is arranged in parallel, offset in relation to plane 901.

In addition, support elements 121, 131 also extend into plane 905 in the standby position; and support elements 122, 132 extend into plane 906 in the standby position. Planes 905, 906 are parallel to one another but offset.

In general, it would be possible that more than two support elements 121, 122, 131, 132 are provided per plane 901, 902.

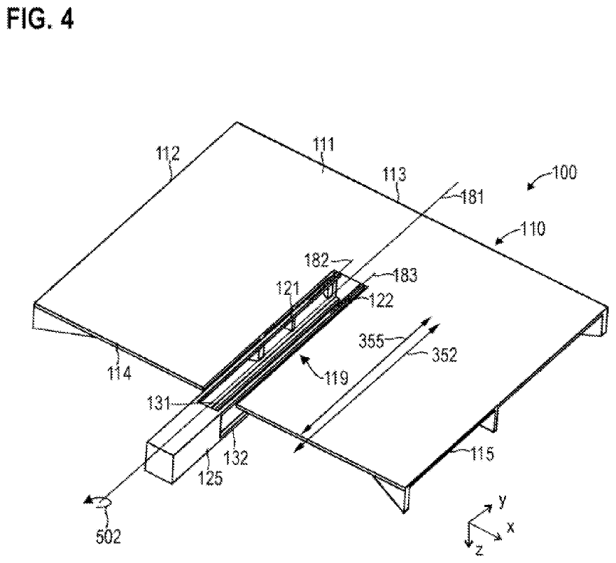

FIG. 4 illustrates aspects in relation to a scanning unit 100 according to various examples. FIG. 4 is a perspective view.

While there are four support elements 121, 122, 131, 132 in the example from FIG. 4, it would also be possible in other examples for there to be a smaller or larger number of support elements.

The example from FIG. 4 essentially corresponds, in this case, to the example from FIG. 2. In the example from FIG. 4 however, the deflection unit 110, and particularly the mirrored surface 111, has an indentation 119. Support elements 121, 122 extend partially into the indentation 119. Support elements 131, 132 extend below the indentation 119. For example, it would be possible that support elements 121, 122 extend into the indentation 119 generally along at least 40% of their length 352, further optionally along at least 60% of their length, further optionally along at least 80% of their length.

A collision is prevented between the support elements 121, 122, 131, 132 and the inner sides of the indentation 119 due to the pure torsion 501 about the torsion axis 181 (cf. FIG. 3).

In the scenario from FIG. 4, the depth 355 of the indentation 119 is dimensioned such that the indentation 119 extends from side 114 to a center of the mirrored surface 111 and also passed the center of the mirrored surface 111 up to side 113. An especially compact structure of the scanning unit 100 can thereby be achieved. In general, it would be possible that the indentation 119 has a depth 355 that is no less than 20% of the corresponding side lengths of sides 112, 115, into which the indentation 119 extends in parallel, optionally no less than 50%, further optionally no less than 70%. With a round mirrored surface, the depth 355 of the indentation 119 cannot be less than 20% (or optionally 50% or further optionally 70%) of a diameter of the mirrored surface 111.

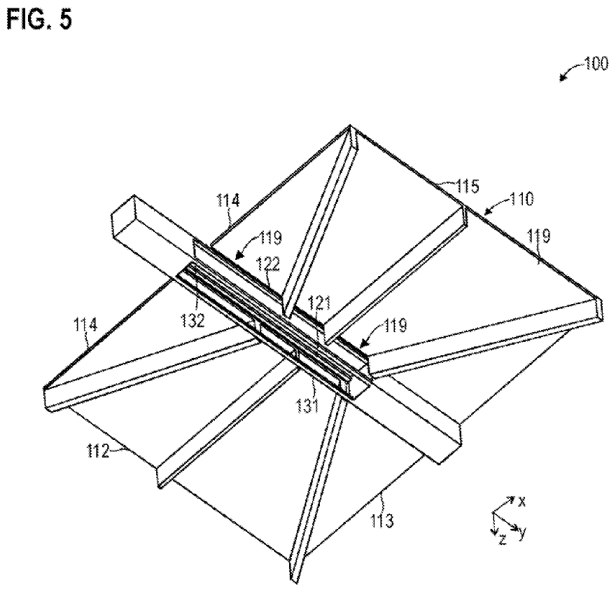

FIG. 5 illustrates aspects in relation to a scanning unit 100 according to various examples. FIG. 5 is a perspective view. The scanning unit 100 according to the example from FIG. 5 corresponds to the scanning unit according to the example from FIG. 4. FIG. 5 shows a rearward perspective view.

FIG. 5 shows, in particular, the back side 116 of the deflection element 110. FIG. 5 shows that the deflection element 110 has structuring on the back sides. In particular, ribs are provided on the back side 116. The ribs increase the stiffness of the deflection element 110 and thus prevent deformation of the mirrored surface 111 during movement. On the other hand, the inert mass of the deflection element 110 is reduced through the provision of the structuring on the back sides such that the resonance frequency of the torsion mode 501 is comparatively large. This can enable high scanning frequencies and thus ultimately fast imaging refresh rates of a LIDAR measurement.

FIG. 5 also shows the indentation 119.

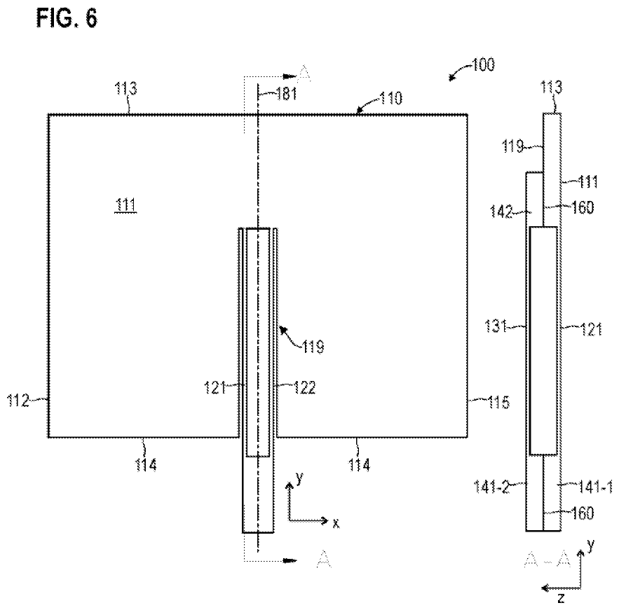

FIG. 6 illustrates aspects in relation to a scanning unit 100 according to various examples. FIG. 6 is a view (left in FIG. 6) and a sectional view along the A-A axis (right in FIG. 6). The scanning unit 100 according to the example from FIG. 6 corresponds to the scanning unit 100 according to the examples from FIGS. 4 and 5.

In particular, the sectional view shows that support element 121 is formed as a single piece with the deflection element 110; while support element 131 is not formed as a single piece with the deflection element 110. This means, for example, that support element 121 and support element 131 are not produced from the same wafer but instead, for example, are bonded to one another or connected to one another by means of a wafer bonding process. FIG. 6 shows the contact surfaces 160.

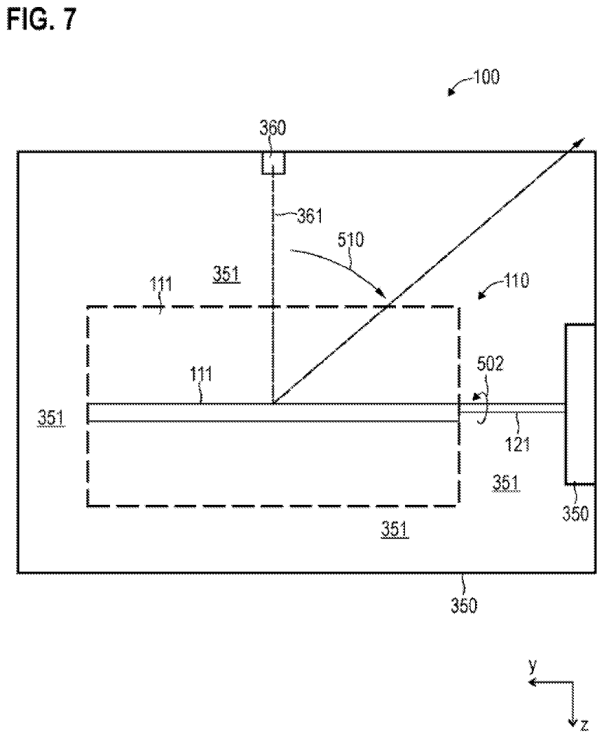

FIG. 7 illustrates aspects in relation to a scanning unit 100 according to various examples. FIG. 7 is a schematic view.

In particular, FIG. 7 illustrates aspects in relation to the fixed structure 350 which defines a clearance 351, in which the deflection element 111 can move during deflection 502—for example, by means of excitation of the torsion 501 by means of a suitable actuator. In the example from FIG. 7, the deflection element 110 is shown in the standby state (solid line in FIG. 7) and in the deflected state (dashed line in FIG. 7). FIG. 7 shows that the clearance 351 is formed in order to enable comparatively large deflections 502 of the deflection element 110. Large deflection angles 510 of light 361 can thereby be achieved. For example, the clearance 351 could be formed in order to enable a deflection of the deflection element 110 of at least ±45°, optionally at least ±80°, further optionally of at least ±120°, further optionally of at least ±180°. This can be possible particularly with side lengths 353 in a range of from 3 mm to 15 mm.

Such a large clearance 351 is particularly thereby achieved in that the fixed structure 350 is not formed as a single piece with the deflection element 110. In particular, the fixed structure 350 does not form an integrally produced frame such as is the case, for example, in connection with conventional MEMS techniques. Therefore, in the techniques described herein, it is not necessary to release the clearance 351 in a wafer, for example, by means of etching processes; instead, the clearance 351 can be formed by means of suitable dimensioning of a housing defined by the fixed structure 350.

FIG. 7 also illustrates aspects in relation to the deflection of light. In the example from FIG. 7, the light 361 impacts the mirrored surface 111 perpendicularly in the standby position of the deflection element 110. This means that the light 361 is propagated from a light source 360—for example a laser—to the mirrored surface 111 along a beam path which is aligned in the Z direction. However, sliding angles of incidence are also possible, i.e. beam paths that are tilted in relation to the Z direction.

FIG. 7 shows the corresponding deflection angle 510 that is achieved due to the deflection 502 of the mirrored surface 111 (in FIG. 7, the mirrored surface is in the standby position perpendicular to the drawing plane and is rotated into the drawing plane as the deflection 502 increases).

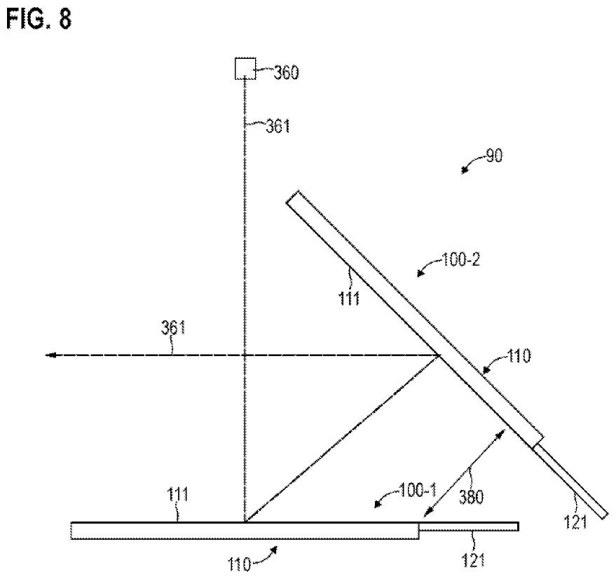

FIG. 8 illustrates aspects in relation to a scanner 90. The scanner 90 comprises a first scanning unit 100-1 and a second scanning unit 100-2. The two scanning units 100-1, 100-2 may be formed in accordance with the previously discussed examples (in FIG. 8, scanning units 100-1, 100-2 are only shown schematically). FIG. 8 shows that the laser light 361 is deflected initially, starting from the laser light source 360, by the mirrored surface 111 of scanning unit 100-1 and is subsequently deflected by the mirrored surface 111 of scanning unit 100-2. This enables a 2-D superposed deflection of the laser light 361 such that the laser light 361 can be scanned in 2-D. A corresponding superposed figure is obtained that defines the scanning region.

FIG. 8 also shows the shortest distance 380 between the circumference of the mirrored surface 111 of scanning unit 100-1 as well as the circumference of the mirrored surface 111 of scanning unit 100-2. In the example from FIG. 8, the mirrored surface 111 of scanning unit 100-1 is tilted 45° in relation to the mirrored surface 111 of scanning unit 100-2. A comparatively short distance 380 can be achieved by means of such an arrangement; a high degree of integration of the scanner 90 can thereby be enabled. The distance 380 must be dimensioned largely enough such that no collision occurs during deflection 501 of the deflection elements 110.

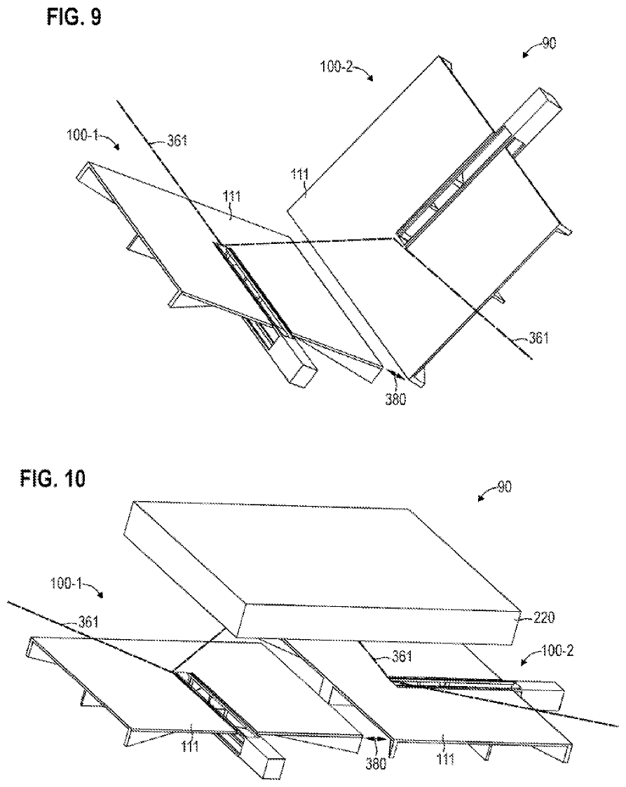

FIGS. 9 and 10 also illustrate aspects in relation to a scanner 90. In the example from FIGS. 9 and 10, the distance 380 between the circumferences of the mirrored surfaces 111 of the two scanning units 100-1, 100-2 can be further reduced as compared to the example from FIG. 8. In the example from FIGS. 9 and 10, this is enabled by means of the sliding angle of incidence of the light 361.

In the example from FIG. 9, the planes defined by the mirrored surfaces 111 of scanning units 100-1, 100-2 have an angle of 90° in relation to one another. In the example from FIG. 10, the planes defined by the mirrored surfaces 111 of scanning units 100-1, 100-2 have an angle of 0° in relation to one another, i.e. they are aligned with one another. In general, these planes could also be slightly tilted, i.e. have an angle, for example, that is no greater than 5°. To that end, a further deflection element 220 with a further mirrored surface is used (not visible in the view from FIG. 10 and facing the mirrored surfaces 111 of scanning units 100-1, 100-2), in the example from FIG. 10. The deflection element 220 is not deflected together with the deflection elements 110 of the scanning units 100-1, 100-2, i.e. it has a fixed position in relation to the fixed structure 350. The mirrored surface of deflection element 220 is parallel to the mirrored surfaces 111 of scanning units 100-1, 100-2; in general, however, a small angle of no more than 5°, for example, could be formed with the mirrored surfaces 111.

In FIGS. 8-10, the circumferences of the mirrored surfaces 111 of the two scanning units 100-1, 100-2 generally have a distance 380 with respect to one another that is less than 25% of the circumferential length of the circumference of the mirrored surfaces 111, optionally less than 10%, further optionally less than 2%. Such short distances 380 can enable small dimensioning of the scanner 90 and thus flexible use in different application areas. Typically, the shortest distances 380 are achieved by means of the implementation according to FIG. 10.

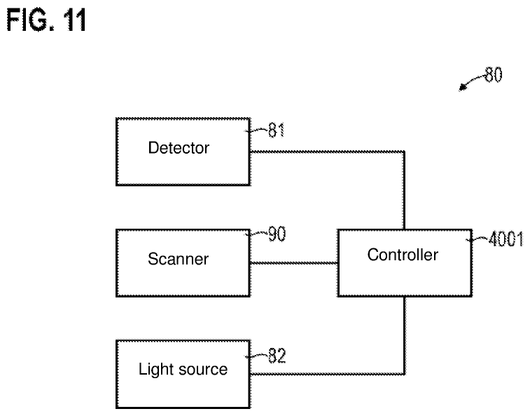

FIG. 11 illustrates aspects in relation to a LIDAR system 80. The LIDAR system 80 comprises a scanner 90, which may be formed, for example, according to the various implementations described herein. The scanner 90 may comprise one or two or more scanning units (not shown in FIG. 11).

The LIDAR system 80 also comprises a light source 360. For example, the light source 360 could also be formed as a laser diode, which emits pulsed laser light 361 in the infrared range with a pulse length in a range of nanoseconds.

The light 361 of the light source 360 can strike then one or more mirrored surfaces 111 of the scanner 90. Depending on the orientation of the deflection element, the light 361 is deflected at different angles 510. The light emitted by the light source 361 is often also characterized as the primary light. Different scanning angles are thereby implemented.

The primary light can then strike an environmental object of the LIDAR system 80. The primary light reflected in this manner is characterized as secondary light. The secondary light may be detected by a detector 82 of the LIDAR system 80. Based on a travel time, which can be determined as a time delay between the emitting of the primary light by the light source 81 and the detecting of the secondary light by the detector 82, a distance between the light source 361 and/or the detector 82 and the environmental object can be determined by means of a controller 4001.

In some cases, the emitter aperture can be the same as the detector aperture. This means that the same scanner 90 can be used to scan the detector aperture. For example, the same deflection elements can be used in order to emit primary light and to detect secondary light. A beam splitter can then be provided to split primary and secondary light. Such techniques may make it possible to achieve an especially high level of sensitivity. This is the case, because the detector aperture can be aligned and limited in the direction in which the secondary light arrives. Ambient light is reduced by spatial filtering, because the detector aperture can be dimensioned smaller.

In addition to this distance measurement, a lateral position of the environmental object can also be determined, for example, by the controller 4001. This can occur by means of monitoring the position and/or orientation of the one or the several deflection units of the scanner 90. In doing so, the position and/or orientation of the one or several deflection units at the moment the light 361 strikes may correspond to a deflection angle 510; the lateral position of the environmental object can be deduced therefrom.

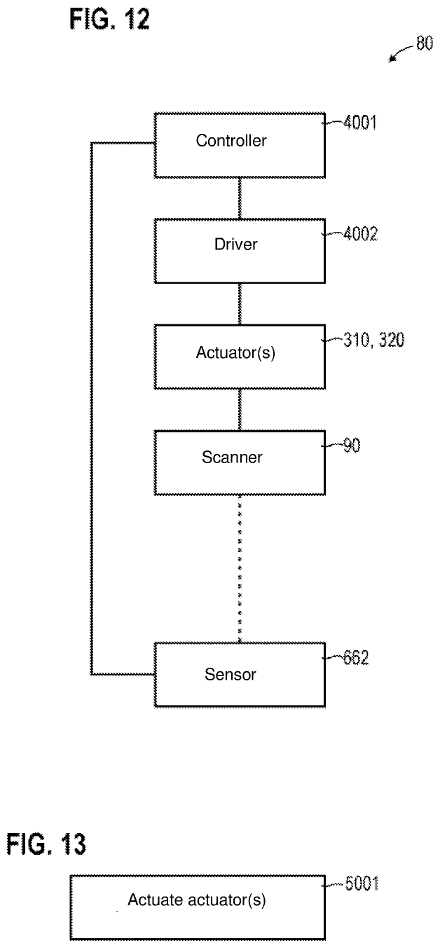

FIG. 12 illustrates aspects in relation to a LIDAR system 80. The LIDAR system 80 comprises a controller 4001, which could be implemented, for example, as a microprocessor or application-specific integrated circuit (ASIC). The controller 4001 could also be implemented as a field-programmable gate array (FPGA). The controller 4001 is set up to output control signals to a driver 4002. For example, the control signals could be output in digital or analog form. These control signals can be configured for exciting the torsion mode in the support elements of the scanner 90 and, for example, for damping one or more transverse modes in the support elements.

The driver 4002 is set up, in turn, to generate one or more voltage signals and to output them to corresponding electrical contacts of the one or more actuators for driving a resonant movement of the support elements. Typical amplitudes of the voltage signals are in a range of from 50 V to 250 V. Examples of actuators include magnets, interdigital electrostatic comb structures, and piezo bending actuators.

The actuators 310,320 are, in turn, coupled to the scanner 90. One or more deflection elements of the scanner 90 are thereby deflected. The environmental region of the scanner 90 can thereby be scanned with light 361. The actuators are configured according to various examples in order to resonantly excite the torsion mode of the support elements of the scanner 90.

FIG. 12 further shows that there is a coupling between the controller 4001 and a sensor 662. The sensor is configured to monitor the deflection of the deflection element or of the deflection elements. The controller 4001 can be set up in order to actuate the one or more actuators 310, 320 based on the signal of the sensor 662. Monitoring of the deflection 501 by the controller 4001 can occur by means of such techniques. If necessary, the controller 4001 can adapt the actuation of the driver 4002 in order to reduce deviations between a desired deflection and an observed deflection.

For example, it would be possible that a closed-loop control is implemented. For example, the closed-loop control may comprise the setpoint amplitude of the movement as a control variable. For example, the closed-loop control may comprise the actual amplitude of the movement as a control variable. In doing so, the actual amplitude of the movement could be based on the signal of the sensor 662. In particular, the torsion mode can be specifically resonantly excited by means of the close-loop control, and the transverse mode can be damped in a targeted manner.

FIG. 13 is a flowchart of an exemplary method. For example, the method according to FIG. 13 could be executed by the controller 4001 of the LIDAR system 80.

In block 5001, at least one actuator is actuated in order to deflect at least one support element, which extends into a plane defined by a mirrored surface of a deflection element, to deflect resonantly in relation to a fixed structure. For example, a torsion could be excited, e.g. resonantly.

In this case, the deflection element is self-supporting, relative to the fixed structure, through a continuous circumferential angle of at least 200° of a circumference of the mirrored surface.

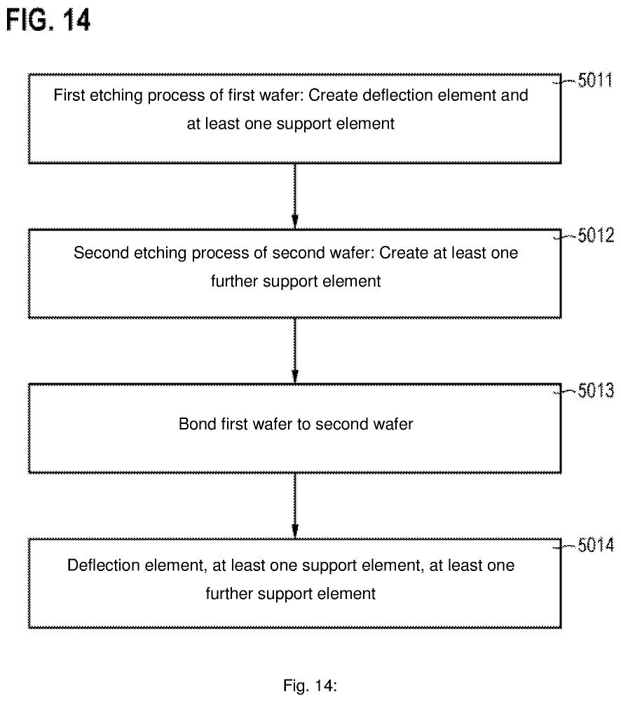

FIG. 14 is a flowchart of an exemplary method. FIG. 14 illustrates aspects in relation to the production of a scanning unit. For example, a scanning unit could be produced according to the method in FIG. 14, as has been described in connection with the figures shown herein.

Initially, a first wafer is processed in block 5011 in a first etching process. In the first etching process, a deflection element and at least one support element are created in the first wafer. The at least one support element extends away from the deflection element. For example, the at least one support element could extend away from a circumference of the deflection element. For example, the at least one support element could extend into a plane with the deflection element; for example, the at least one support element could extend into a plane defined by a mirrored surface of the deflection element (wherein mirroring of the mirrored surface, for example through the depositing of gold or aluminum, can only happen subsequently).

Then, a second wafer is processed in block 5012 in a second etching process. In the second etching process, at least one further support element is created in the second wafer. The at least one further support element may be formed complementary to the support element in the first wafer. Corresponding techniques have been described, for example, previously in relation to FIGS. 4-6.

The bonding of the first wafer to the second wafer then takes place in block 5013. For example, suitable contact surfaces can be defined at the ends of the support elements which enable bonding in connection with the at least one support element from block 5011 and the at least one further support element from block 5012 (cf. FIG. 6: 141-1 with 141-2, and 142 with 119). Anodic bonding etc., for example, would be possible.

The release of the thusly defined scanning unit then occurs in block 5014 in the example from FIG. 14. In other examples, the release could also take place before block 5013.

In summary, previous techniques have been shown in which one or more support elements are attached to one side of a mirrored surface. Parallel kinematics are thereby supported during the elastic actuation of the corresponding deflection element. If one or more support elements are only attached to one side of the mirrored surface, the surface area consumed by the structure on the wafer increases. Due to the one-sided suspension, the deflection element, however, can only be mounted on one side and does not require any stiff support frame. The deflection element can thereby be self-supporting, which simplifies the suspension and enables large movements.

Obviously, the features of the previously described embodiments and aspects of the invention can be combined with one another. In particular, the features cannot only be used in the described combinations but also in other combinations or in isolation without extending beyond the scope of the invention.

For example, techniques have been previously described in which several support elements are used. In some examples however, only one single support element may be used.

Furthermore, various techniques in relation to the movement of scanning units associated with LIDAR measurements have been described previously. Corresponding techniques may also be used, however, in other applications, e.g. for projectors or laser scanning microscopes etc.

1. A scanning unit for scanning light, comprising:
a deflection element with a mirrored surface,
at least one support element, which extends away from a circumference of the mirrored surface into a plane and which is configured to elastically couple the deflection element to a fixed structure, wherein the mirrored surface also extends into the plane,
at least one further support element, which extends offset to the plane defined by the at least one support element and which is configured to elastically couple the deflection element to the fixed structure, and
a controller, which is configured to actuate at least one actuator, in order to resonantly excite a torsion mode of the at least one support element and of the at least one further support element,
wherein the deflection element is self-supporting, relative to the fixed structure, through a continuous circumferential angle of at least 200° of a circumference of the mirrored surface.

2. The scanning unit according to claim 1,
wherein the at least one support element comprises a first support element and a second support element,
wherein the at least one further support element comprises a further first support element and a further second support element.

3. The scanning unit according to claim 2,
wherein the first support element and the first further support element lie in a first plane,
wherein the second support element and the further second support element lie in a second plane,
wherein the first plane and the second plane form an angle of no greater than 5° with one another, optionally of no greater than 1°.

4. The scanning unit according to claim 2,
wherein an end of the first support element, said end adjoining the deflection element, and an end of the second support element, said end adjoining the deflection element, have a distance with respect to one another which is no greater than 40% of the length of the circumference of the mirrored surface.

5. The scanning unit according to claim 1,
wherein the at least one further support element extends into a further plane, which is parallel to the plane defined by the at least one support element.

6. The scanning unit according to claim 1,
wherein the at least one support element and the deflection element are formed as a single piece,
wherein the at least one support element and the at least one further support element are not formed as a single piece.

7. The scanning unit according to claim 1,
wherein the at least one support element comprises a first support element and a second support element,
wherein a central axis of the first support element and a central axis of the second support element form an angle with one another in the standby state that is no greater than 20°, optionally no greater than 5°, further optionally no greater than 1°.

8. The scanning unit according to claim 1,
wherein a length of each of the at least one support element or of each of the at least one further support element is in a range of from 3 mm to 15 mm, and/or
wherein a width of each of the at least one support element or of each of the at least one further support element is in a range of from 50 μm to 250 μm.

9. The scanning unit according to claim 1,
wherein a cross-section of each of the at least one support element and/or of each of the at least one further support element is square-shaped.

10. The scanning unit according to claim 1,
wherein the at least one support element and the at least one further support element are formed respectively as rod-shaped torsion springs.

11. The scanning unit according to claim 1,
wherein the at least one actuator is arranged at an end of the at least one support element, said end facing toward the fixed structure, and comprises one or more piezo bending actuators.

12. The scanning unit according to claim 1,
wherein the at least one support element and the at least one further support element are arranged parallel to one another.

13. The scanning unit according to claim 1,
wherein the at least one support element and the at least one further support element are each connected to a contact surface in an end region facing toward the fixed structure.

14. The scanning unit according to claim 1,
wherein the at least one further support element is connected to a back side of the deflection element, said back side being opposite the mirrored surface, via an interface element.

15. The scanning unit according to claim 1,
wherein a thickness of the at least one support element perpendicular to the mirrored surface is less than a thickness of the deflection element perpendicular to the mirrored surface.

16. The scanning unit according to claim 1,
wherein the mirrored surface has an indentation,
wherein the at least one support element extends at least partially into the indentation,
wherein the at least one support element extends into the indentation optionally along at least 40% of its length, further optionally along at least 60% of its length, further optionally along at least 80% of its length.

17. The scanning unit according to claim 1, which further comprises:
the fixed structure, which defines a clearance, in which the deflection element is arranged,
wherein the clearance is formed in order to enable a deflection of the deflection element through torsion of the at least one support element of at least ±45°, optionally of at least ±80°, further optionally of at least ±180°.

18. The scanning unit according to claim 1,
wherein the circumference of the mirrored surface has several sides,
wherein only one of the several sides is coupled to the fixed structure.

19. A method for operating a scanning unit for scanning light, wherein the method comprises:
actuating at least one actuator in order to resonantly deflect, relative to a fixed structure, at least one support element, which extends into a plane defined by a mirrored surface of a deflection element, with a torsion mode, and in order to furthermore resonantly deflect, relative to the fixed structure, at least one further support element, which extends at an offset to the plane,
wherein the deflection element is self-supporting, relative to the fixed structure, through a continuous circumferential angle of at least 200° of a circumference of the mirrored surface.

20. A method for producing a scanning unit for scanning light, wherein the method comprises:
in a first etching process of a first wafer: creating a deflection element and at least one support element, which extends away from the deflection element, in the first wafer,
in a second etching process of a second wafer: creating at least one further support element, in the second wafer,
bonding the first wafer to the second wafer, and
releasing the deflection element, the at least one support element, and the at least one further support element.
